(19) United States
(12) Patent Application Publication
(10) Pub. No.: US 2014/0241575 A1
(43) Pub. Date: Aug. 28, 2014

(54) Wearable display-based remote collaboration apparatus and method

(71) Applicant: ELECTRONICS AND TELECOMMUNICATIONS RESEARCH INSTITUTE, Daejeon-City (KR)

(72) Inventors: Ki-Suk Lee, Daejeon (KR); Dong-Sik Jo, Daejeon (KR); Ki-Hong Kim, Daejeon (KR); Yong-Wan Kim, Daejeon (KR); Hong-Kee Kim, Daejeon (KR)

(73) Assignee: ELECTRONICS AND TELECOMMUNICATIONS RESEARCH INSTITUTE, Daejeon-City (KR)

(21) Appl. No.: 14/077,782

(22) Filed: Nov. 12, 2013

(30) Foreign Application Priority Data
Feb. 27, 2013 (KR) 10-2013-0021294

(51) Int. Cl. G06K 9/00

(52) U.S. Cl. CPC G06K 9/00624
USPC 382/103

(57) ABSTRACT

Disclosed herein are a wearable display-based remote collaboration apparatus and method. The wearable display-based remote collaboration apparatus includes an image acquisition unit, a recognition unit, an image processing unit, and a visualization unit. The image acquisition unit obtains image information associated with the present point of time of a worker. The recognition unit recognizes the location and motion of the worker based on the obtained image information. The image processing unit matches a virtual object, corresponding to an object of work included in the obtained image information, with the image information, and matches a motion of the object of work, matched with the image information, with the image information based on manipulation information. The visualization unit visualizes the image information processed by the image processing unit, and outputs the visualized image information.

### CROSS REFERENCE TO RELATED APPLICATION

This application claims the benefit of Korean Patent Application No. 10-2013-0021294, filed on Feb. 27, 2013, which is hereby incorporated by reference in its entirety into this application.

### BACKGROUND OF THE INVENTION

1. Technical Field

The present invention relates generally to technology that can examine equipment in collaboration with an expert at a remote location and, more particularly, to a wearable display-based remote collaboration apparatus and method that can examine equipment in collaboration with an expert at a remote location in which accessibility is limited, thereby enabling the equipment to be effectively operated.

2. Description of the Related Art

When a problem occurs with equipment during operation, a worker examines the equipment using a maintenance manual. A maintenance support system is provided in order to assist the worker in examining the equipment.

In general, a maintenance support system that is provided to examine equipment includes a handheld terminal in which a maintenance manual is contained. Accordingly, the maintenance support system enables a user to conveniently carry the terminal to a site in which the equipment is installed and to easily search the maintenance manual, thereby supporting maintenance.

A maintenance support system may assist a worker in examining equipment by providing a maintenance procedure or maintenance-related information via a handheld terminal. An example of a maintenance support system (or method) is Korean Patent Application Publication No. 10-2010-0024313 entitled “Method of Supporting Automobile Maintenance.”

However, the conventional maintenance support system has a limited effect because if a user lacks the understanding of equipment even although the corresponding information is visualized, it is difficult for the user to proceed with work.

In order to solve the above problem, a maintenance-related expert performs maintenance using the maintenance support system together with a worker.

However, the conventional maintenance support system is problematic in that the cost of maintenance increases because both a worker and an additional expert must perform work together and in that the stability of maintenance decreases when a relatively small number of experts perform a plurality of maintenance tasks at the same time.

Furthermore, a problem arises in that rapid countermeasures cannot be taken because a manager cannot perform maintenance along with a worker if a problem occurs with equipment in an equipment operating environment (e.g., in an ocean-going vessel, a spacecraft or the like) in which the number of persons on board as well as accessibility are limited.

### SUMMARY OF THE INVENTION

Accordingly, the present invention has been made keeping in mind the above problems occurring in the prior art, and an object of the present invention is to provide a wearable display-based remote collaboration apparatus and method that, when a non-specialized worker performs maintenance work, can visualize a maintenance work procedure and method provided by an expert at a remote location and can provide the maintenance work procedure and method to the worker.

Another object of the present invention is to provide a wearable display-based remote collaboration apparatus and method that, when an equipment operator detects a failure with equipment in operation, can support collaboration through images, motions, and voice over a network so that the equipment operator can directly perform maintenance on the equipment with an expert assistance.

In accordance with an aspect of the present invention, there is provided a wearable display-based remote collaboration apparatus, including an image acquisition unit configured to obtain image information associated with the present point of time of a worker; a recognition unit configured to recognize the location and motion of the worker based on the obtained image information; an image processing unit configured to match a virtual object corresponding to an object of work included in the obtained image information, with the image information, and to match the motion of the object of work matched with the image information, with the image information based on manipulation information; and a visualization unit configured to visualize the image information processed by the image processing unit, and to output the visualized image information.

The recognition unit may include a location recognition module configured to recognize the location of the worker based on the location information that is included in a signal from a Global Positioning System (GPS) or a signal from a wireless sensor network.

The location recognition module may recognize the location of the worker based on the obtained image information and information about an image of a work environment that has been previously obtained if the GPS or the wireless sensor network is unavailable.

The recognition unit may include a motion recognition module configured to recognize the motion of the worker based on at least one of the obtained image information and information about the depth of a work space that is included in the obtained image information.

The image processing unit may detect the virtual object, corresponding to the object of work included in the obtained image information, based on the location and motion of the worker recognized by the recognition unit, and may match the detected virtual object with the obtained image information.

The image processing unit may track the virtual object matched with the image information, based on the manipulation information, and may send the results of the tracking to the visualization unit.

The wearable display-based remote collaboration apparatus may further include a virtual object storage unit configured to store virtual objects that are generated based on blueprints of equipment.

The wearable display-based remote collaboration apparatus may further include a communication unit configured to send the obtained image information to a collaboration support server and to receive manipulation information corresponding to the transmitted image information from the collaboration support server.

The communication unit may send the image information with which the virtual object has been matched by the image processing unit to the collaboration support server.

The wearable display-based remote collaboration apparatus may further include a depth information acquisition unit configured to obtain information about the depth of a work space including at least one of equipment, a part, and a hand of the worker included in the image information that is obtained by the image acquisition unit.

In accordance with another aspect of the present invention, there is provided a wearable display-based remote collaboration method, including obtaining, by an image acquisition unit, image information associated with the present point of time of a worker that is located at a work site; recognizing, by a recognition unit, the location and motion of the worker based on the obtained image information; matching, by an image processing unit, a virtual object, corresponding to an object of work included in the obtained image information, with the image information; matching, by the image processing unit, the motion of the virtual object with the image information, based on manipulation information that is received from a collaboration support server; and visualizing, by a visualization unit, the matched image information, and outputting, by a visualization unit, the visualized image information.

Recognizing the location and motion of the worker may include recognizing, by the recognition unit, the location of the worker based on location information that is included in a signal from a GPS or a signal from a wireless sensor network; or recognizing, by the recognition unit, the location of the worker based on the obtained image information and information about an image of a work environment that has been previously obtained.

Recognizing the location and motion of the worker may include recognizing, by the recognition unit, the motion of the worker based on at least one of the obtained image information and information about the depth of a work space that is included in the obtained image information.

Matching the virtual object with the image information may include detecting, by the image processing unit, the virtual object, corresponding to the object of work included in the obtained image information, based on the location and motion of the worker recognized in the step of recognizing the location and motion of the worker; and matching, by the image processing unit, the detected virtual object with the obtained image information.

Visualizing the matched image information and outputting the visualized image information may include tracking, by the image processing unit, the virtual object, matched with the image information, based on the manipulation information, and sending, by the image processing unit, the results of the tracking to the visualization unit.

The wearable display-based remote collaboration method may further include obtaining, by a depth information acquisition unit, the depth information of the obtained image information.

Obtaining the depth information may include obtaining, by the depth information acquisition unit, information about the depth of a work space including at least one of equipment, a part, a hand of the worker that are included in the obtained image information.

The wearable display-based remote collaboration method of claim 11, further comprising sending, by the communication unit, the matched image information to the collaboration support server.

Sending the image information to the collaboration support server may include sending, by the communication unit, the obtained image information to the collaboration support server.

The wearable display-based remote collaboration method may further include receiving, by the communication unit, manipulation information corresponding to the transmitted image information from the collaboration support server.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a maintenance support system according to an embodiment of the present invention;

FIG. 2 is a diagram illustrating the configuration of a wearable display-based remote collaboration apparatus according to an embodiment of the present invention;

FIG. 3 is a diagram illustrating the recognition unit of FIG. 2;

FIG. 4 is a flowchart illustrating a wearable display-based remote collaboration method according to an embodiment of the present invention;

FIG. 5 is a flowchart illustrating the recognition step illustrated in FIG. 4; and

FIG. 6 is a flowchart illustrating the step of matching a virtual object with image information illustrated in FIG. 4.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted. The embodiments of the present invention are intended to fully describe the present invention to a person having ordinary knowledge in the art. Accordingly, the shapes, sizes, etc. of elements in the drawings may be exaggerated to make the description clear.

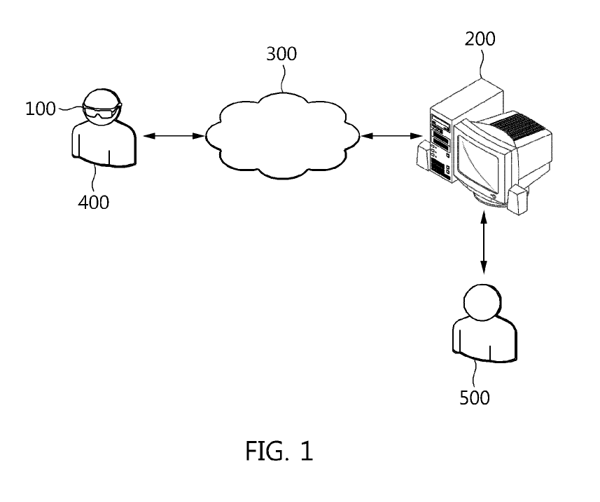

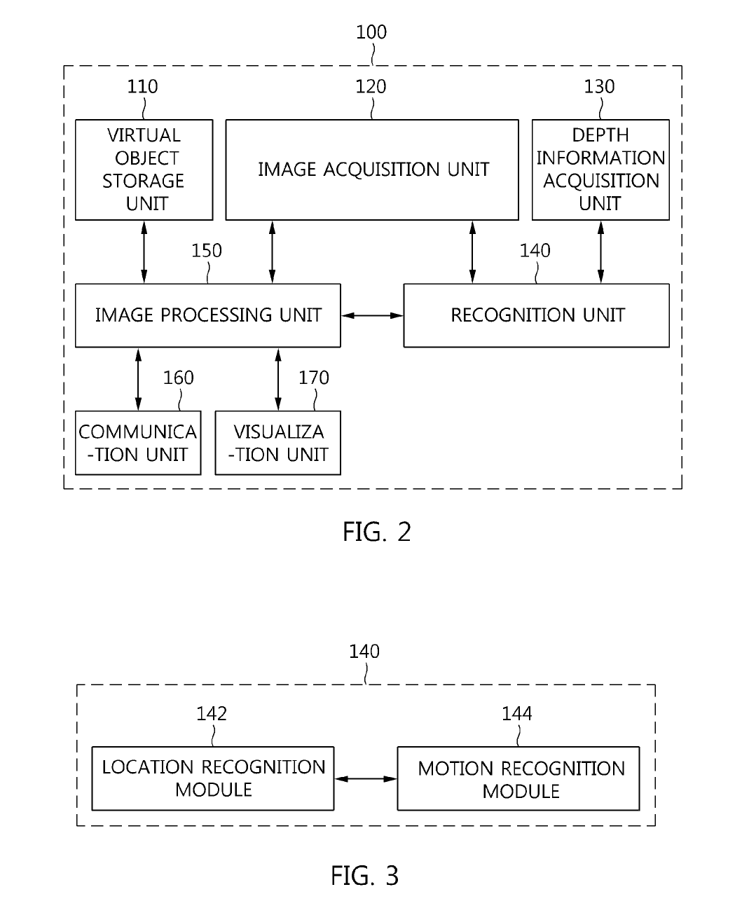

A wearable display-based remote collaboration apparatus according to an embodiment of the present invention will be described in detail below with reference to the accompanying drawings. FIG. 1 is a diagram illustrating the configuration of a maintenance support system according to an embodiment of the present invention, FIG. 2 is a diagram illustrating the configuration of a wearable display-based remote collaboration apparatus according to an embodiment of the present invention, and FIG. 3 is a diagram illustrating the recognition unit of FIG. 2.

As illustrated in FIG. 1, the maintenance support system of the present invention includes a wearable display-based remote collaboration apparatus 100 and a collaboration support server 200. The wearable display-based remote collaboration apparatus 100 and the collaboration support server 200 are connected over a wired/wireless network 300.

The wearable display-based remote collaboration apparatus 100 is an apparatus that is used by a worker 400 at a maintenance site. The wearable display-based remote collaboration apparatus 100 includes a wearable display device (e.g., a Head Mounted Display (HMD)), a Face Mounted Display (FMD), an Eye Glasses Display (EGD), and a Near Eye Display (NED)). The wearable display-based remote collaboration apparatus 100 matches information about a maintenance method input by an expert 500, with a real space belonging to the field of view of the worker 400, and displays the matched information. For this purpose, as illustrated in FIG. 2, the wearable display-based remote collaboration apparatus 100 includes a virtual object storage unit 110, an image acquisition unit 120, a depth information acquisition unit 130, a recognition unit 140, an image processing unit 150, a communication unit 160, and a visualization unit 170.

The virtual object storage unit 110 stores virtual objects that are generated based on the blueprints of maintenance target equipment. That is, the virtual object storage unit 110 stores three-dimensional (3D) virtual objects that are generated through 3D data conversion based on the blueprints. In this case, the virtual object storage unit 110 stores 3D virtual objects generated for respective parts of the equipment so that the parts can be measured, structured and manipulated. Furthermore, these 3D virtual objects may be constructed in various 3D data formats. These 3D virtual objects are preferably constructed in a 3D data format that is a standard having excellent compatibility, because most 3D data formats support a hierarchical structure. The virtual object storage unit 110 may be implemented using caches depending on the work environment of the worker 400 so that the virtual objects may be rapidly input and output.

The image acquisition unit 120 is installed in the wearable display device, and obtains image information that is associated with the present point of time of the worker 400. That is, the image acquisition unit 120 obtains image information that is shared by the expert 500 at a remote location to perform maintenance collaboration or that becomes a basis for tracking the motion of the worker 400. In this case, the image acquisition unit 120 is fixedly installed in the wearable display device to detect the physical location of an object of work (i.e., equipment or a part) that is included in the image information in order to match the obtained image information with a virtual object.

The image acquisition unit 120 sends the obtained image information to the recognition unit 140. The image acquisition unit 120 sends the obtained image information to the collaboration support server 200 via the communication unit 160.

The depth information acquisition unit 130 is formed of a structured light-type depth sensor, and obtains information about the depth of an image information. That is, the depth information acquisition unit 130 obtains information about the depth of an image that is used to more precisely obtain information about a space where the worker 400 is working.

The depth information acquisition unit 130 obtains depth information by detecting a work space at a location (e.g., a location on the shoulder of the worker 400) where the motion (in particular, an indication by the hand) of the object of work and the worker 400 can be obtained. In this case, the depth information acquisition unit 130 obtains information about the depth of the work space (e.g., equipment, a part, or the hand of the worker 400) included in the image information.

The recognition unit 140 recognizes the location and motion of the worker 400. That is, the recognition unit 140 recognizes the location of the worker 400 in order to reduce the search area of the virtual object storage unit 110 by determining a spatial location in a real maintenance work environment. The recognition unit 140 recognizes the motion of the worker 400 in order to recognize equipment or a part, that is, the object of work. For this purpose, as illustrated in FIG. 3, the recognition unit 140 includes a location recognition module 142 and a motion recognition module 144.

The location recognition module 142 recognizes the location of the worker 400 using a Global Positioning System (GPS) or the wireless sensor network 300. That is, the location recognition module 142 recognizes the location of the worker 400 based on location information that is included in a signal from the GPS or a signal from the wireless sensor network 300.

The location recognition module 142 may recognize the location of the worker 400 based on image information obtained by the image acquisition unit 120. That is, if a GPS or the wireless sensor network 300 is unavailable, the location recognition module 142 recognizes the location of the worker 400 in such a way as to estimate the location of the worker 400 by comparing image information obtained by the image acquisition unit 120, with information about an image of a work environment that has been previously obtained.

The location recognition module 142 may use the combination of a location recognition method using a GPS or the wireless sensor network 300 and a location recognition method using image information in order to increase accuracy in location recognition.

The motion recognition module 144 recognizes the motion of the worker 400 based on image information obtained by the image acquisition unit 120 and depth information obtained by the depth information acquisition unit 130. That is, the motion recognition module 144 tracks both hands of the worker 400 by detecting the locations of the hands of the worker 400 for each frame of the image information. In this case, the motion recognition module 144 uses depth information in order to increase the accuracy of detection. That is, the motion recognition module 144 recognizes the motion of the worker 400 only when depth information corresponding to the location of each hand of the worker 400 is placed in a constant valid depth area in order to minimize errors in motion recognition.

The image processing unit 150 detects a virtual object corresponding to the object of work (i.e., equipment or a part) that is included in image information obtained by the image acquisition unit 120. That is, the image processing unit 150 detects a virtual object, corresponding to the object of work (i.e., equipment or a part) included in image information, from the virtual object storage unit 110. In this case, the image processing unit 150 detects a virtual object, corresponding to the object of work (i.e., equipment or a part) that is manipulated (or selected) by the worker 400, based on the results of the recognition (i.e., the results of location recognition, the results of motion recognition, or both) by the recognition unit 140. The image processing unit 150 maps the detected virtual object to image information.

The image processing unit 150 matches the motion of a virtual object, mapped to image information, with the image information based on manipulation information that is provided by the expert 500 and that is input through the communication unit 160. That is, the image processing unit 150 detects a virtual object, selected by the expert 500, and the motion of the expert 500 based on manipulation information that is provided by the expert 500. The image processing unit 150 matches the detected virtual object and the detected motion of the expert 500 with the image information, and sends the matched image information to the visualization unit 170. In this case, if manipulation information for displaying the input information of the expert 500 on a real image in the form of text or an image is received through the communication unit 160, the image processing unit 150 may match the manipulation information with the image information, and may send the matched image information to the visualization unit 170.

The image processing unit 150 tracks the virtual object, mapped to the image information, based on the manipulation information of the expert 500 that is received through the communication unit 160. That is, the image processing unit 150 detects the virtual object, selected by the expert 500, based on the manipulation information of the expert 500. The image processing unit 150 tracks the detected virtual object based on color information and feature point information that are included in the image information. The image processing unit 150 sends the results of the tracking of the virtual object to the visualization unit 170. Accordingly, the virtual object and the image information can be visualized by matching the virtual object with the image information as long as the context of work is maintained even when the field of view of the worker 400 is changed.

The communication unit 160 sends maintenance information, including the image information processed by the image processing unit 150, to the collaboration support server 200. That is, the communication unit 160 sends the image information, matched with the virtual object by the image processing unit 150, or the maintenance information, including the image information obtained by the image acquisition unit 120, to the collaboration support server 200. In this case, the maintenance information may include image information, voice, text, and depth information. In order to minimize an increase in traffic upon sending the image information, the communication unit 160 compresses the maintenance information including the image information, and then sends the compressed information to the collaboration support server 200.

The communication unit 160 receives manipulation information from the collaboration support server 200. That is, the expert 500 inputs information about the manipulation of a virtual object for maintenance work through the collaboration support server 200. The collaboration support server 200 sends the input manipulation information to the communication unit 160. The communication unit 160 sends the received manipulation information to the image processing unit 150. In this case, the communication unit 160 may receive manipulation information for displaying the input information of the expert 500 on a real image in the form of text or an image.

The visualization unit 170 outputs the image information processed by the image processing unit 150. That is, the visualization unit 170 displays the image information (i.e., the virtual object) processed by the image processing unit 150 by visualizing the image information on real equipment. For this purpose, the visualization unit 170 is formed of a wearable display using a transparent optical system. The visualization unit 170 matches information (i.e., a virtual object and a motion of the expert 500) about a maintenance method with a real space that belongs to the field of view of the worker 400, and then displays the matched information. In this case, the wearable display is formed of a monocular or binocular type semi-transparent glasses display in order to provide a visual effect which can be seen while monitoring a manipulating method of existing equipment in a real space, thereby outputting an image.

The collaboration support server 200 outputs the maintenance information received from the wearable display-based remote collaboration apparatus 100. That is, the collaboration support server 200 receives the maintenance information, including image information, voice, text, and a virtual object, from the wearable display-based remote collaboration apparatus 100 that is placed at a maintenance site. The collaboration support server 200 visualizes the received maintenance information, and then outputs the visualized information. If maintenance information including image information with which a virtual object is not matched is received, the collaboration support server 200 may match the virtual object with the image information, may output the matched information, may detect equipment present on the image, may match the detected equipment with the image information, and may visualize the matched information. In this case, the collaboration support server 200 may reconstruct a site where the worker 400 is placed in the form of a 3D space based on the image information and depth information included in the maintenance information, and may then provide the reconstructed site to the expert 500.

The collaboration support server 200 sends the manipulation information, input by the expert 500, to the wearable display-based remote collaboration apparatus 100. That is, the collaboration support server 200 receives the manipulation information that includes a virtual object and the motion of the expert 500. The collaboration support server 200 sends the received manipulation information to the wearable display-based remote collaboration apparatus 100. In this case, the collaboration support server 200 receives the manipulation information that is generated by the input of the expert 500 (e.g., using a mouse, a keyboard or both).

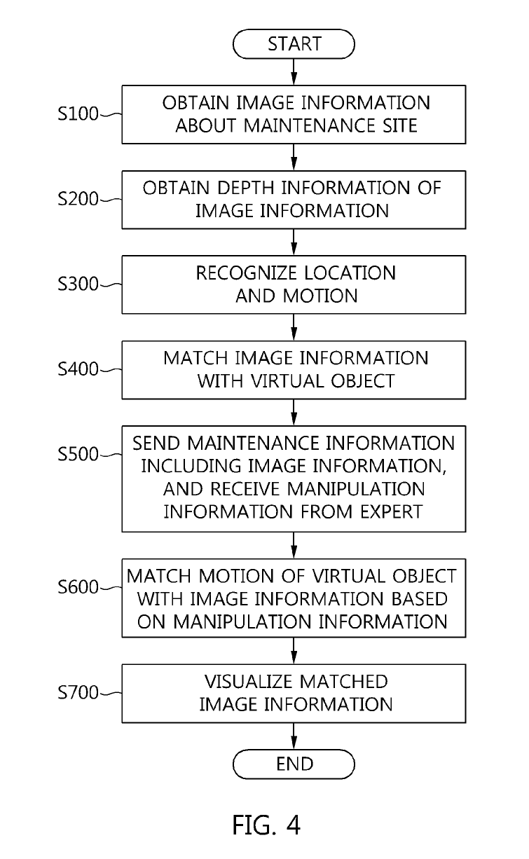

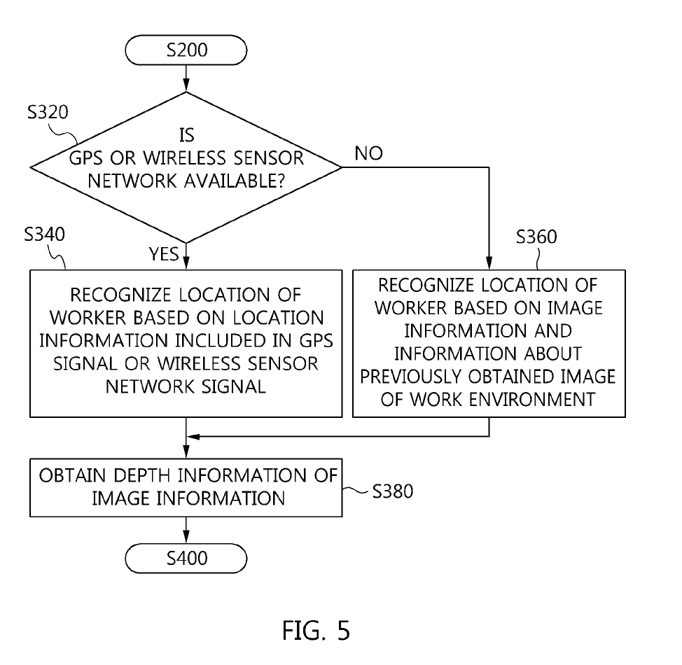

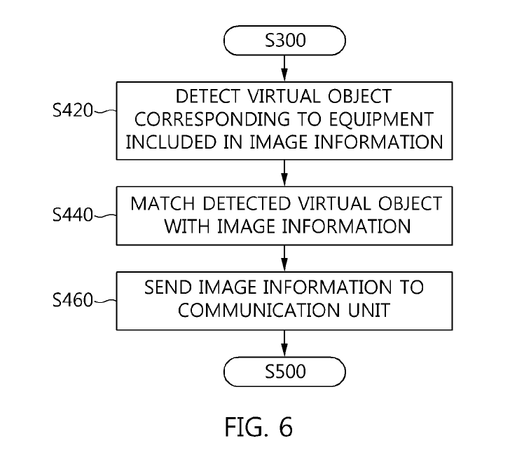

A wearable display-based remote collaboration method according to an embodiment of the present invention will be described in detail below with reference to the accompanying drawings. FIG. 4 is a flowchart illustrating the wearable display-based remote collaboration method according to an embodiment of the present invention, FIG. 5 is a flowchart illustrating the recognition step illustrated in FIG. 4, and FIG. 6 is a flowchart illustrating the step of matching a virtual object with image information illustrated in FIG. 4.

The image acquisition unit 120 obtains image information associated with the present point of time of the worker 400 who is located at a work site at step S100. The image acquisition unit 120 obtains image information that is shared by the expert 500 at a remote location for maintenance collaboration or that becomes a basis for tracking the motion of the worker 400. The image acquisition unit 120 sends the obtained image information to the recognition unit 140.

At step S200, the depth information acquisition unit 130 obtains the depth information of the image information that has been previously obtained. That is, the depth information acquisition unit 130 obtains the depth information of the image information that is used to more accurately obtain information about a space where the worker 400 works. In this case, the depth information acquisition unit 130 obtains the depth information by sensing a work space at a location (e.g., the shoulder part of the worker 400) where the object of work and the motion (in particular, indication by the hand) of the worker 400 can be obtained. The depth information acquisition unit 130 obtains information about the depth of the work space (e.g., equipment, a part, or the hand of the worker 400) that is included in the image information.

The recognition unit 140 recognizes the location and motion of the worker 400 at step S300. This will be described in greater detail below with reference to FIG. 5. The step of recognizing the location and motion of the worker 400 can be basically divided into the step of recognizing the location of the worker 400 and the step of recognizing the motion of the worker 400.

If a GPS or the wireless sensor network 300 is available (YES at step S320), the recognition unit 140 recognizes the location of the worker 400 based on location information that is included in a signal received from the GPS and a signal received from the wireless sensor network 300 at step S340.

If a GPS or the wireless sensor network 300 is unavailable (NO at step S320), the recognition unit 140 recognizes the location of the worker 400 based on information about the image of a work environment, previously obtained using the image information obtained at step S100, at step S360. In this case, the recognition unit 140 may use the combination of a location recognition method using a GPS and the wireless sensor network 300 and a location recognition method using image information in order to increase the accuracy of location recognition.

At step S380, the recognition unit 140 recognizes the motion of the worker 400 based on the image information obtained at step S100 and the depth information obtained at step S200. That is, the recognition unit 140 tracks both hands of the worker 400 by detecting the location of each hand of the worker 400 for each frame of the image information. In this case, the recognition unit 140 may use the depth information in order to increase the accuracy of detection. That is, the recognition unit 140 recognizes the motion of the worker 400 only when depth information corresponding to the location of the hand of the worker 400 is located in a constant valid depth area in order to minimize errors in motion recognition.

The image processing unit 150 matches a virtual object with the image information based on the image information, the depth information, and the results of the recognition at step S400. This step will be described in greater detail below with reference to FIG. 6.

The image processing unit 150 detects a virtual object, corresponding to an object of work (i.e., equipment or a part) included in the image information obtained at step S100, from the virtual object storage unit 110 at step S420. In this case, the image processing unit 150 detects a virtual object, corresponding to the object of work (i.e., equipment or a part) manipulated (or selected) by the worker 400, based on the results of the recognition (i.e., the results of the location recognition, and the results of the motion recognition) at step S300.

The image processing unit 150 matches the detected virtual object with the image information at step S440. That is, the image processing unit 150 matches the virtual object with the image information by mapping the detected virtual object to the location of the object of work included in the image information.

The image processing unit 150 sends the image information with which the detected virtual object has been matched to the communication unit 160 at step S460.

The communication unit 160 sends maintenance information including the image information to the collaboration support server 200 and receives manipulation information, input by the expert 500, from the collaboration support server 200 at step S500. That is, the communication unit 160 sends the image information, matched with the virtual object at step S400, or the maintenance information, including the image information obtained by the image acquisition unit 120, to the collaboration support server 200. In this case, the maintenance information can include image information, voice, text, and depth information. Furthermore, in order to minimize an increase in traffic upon sending the image information, the communication unit 160 compresses the maintenance information including the image information and then sends the compressed information to the collaboration support server 200. The collaboration support server 200 outputs the image information that is received from the communication unit 160. The expert 500 inputs manipulation information about the virtual object for maintenance work based on the output image information. The collaboration support server 200 sends the input manipulation information to the communication unit 160. The communication unit 160 sends the received manipulation information to the image processing unit 150. In this case, the communication unit 160 may receive manipulation information for displaying the input information of the expert 500 on a real image in the form of text or an image.

The image processing unit 150 matches the motion of the virtual object with the image information based on the manipulation information at step S600. The image processing unit 150 detects a virtual object selected by the expert 500 and a motion of the expert 500 based on the manipulation information of the expert 500. The image processing unit 150 matches the detected virtual object and the detected motion of the expert 500 with the image information, and then sends the matched information to the visualization unit 170. In this case, if manipulation information for displaying the input information of the expert 500 on a real image in the form of text or an image is received through the communication unit 160, the image processing unit 150 may match the manipulation information with the image information, and may then send the matched image information to the visualization unit 170.

The visualization unit 170 visualizes the matched image information and outputs the matched image information at step S700. That is, the visualization unit 170 visualizes the image information (i.e., the virtual object), processed by the image processing unit 150, on real equipment, and then displays the visualized image information. In this case, the visualization unit 170 matches information (i.e., the virtual object and the motion of the expert 500) about the maintenance method with a real space belonging to the field of view of the worker 400, and then displays the matched information. Furthermore, the visualization unit 170 provides a visual effect that can be seen upon monitoring a method of manipulating equipment in a real space. In addition, the image processing unit 150 may track the virtual object, mapped to the image information, based on the manipulation information of the expert 500. That is, the image processing unit 150 detects the virtual object, selected by the expert 500, based on the manipulation information of the expert 500. The image processing unit 150 tracks the detected virtual object based on color information and feature point information that are included in the image information. The image processing unit 150 sends the results of the tracking of the virtual object to the visualization unit 170. Accordingly, a virtual object and image information can be visualized by matching the virtual object with the image information as long as the context of work is maintained even when the field of view of the worker 400 is changed.

As described above, in accordance with the present invention, the wearable display-based remote collaboration apparatus and method can visualize a maintenance work procedure and method provided by an expert at a remote location and then provide the visualized work procedure and method to the worker, thereby providing the advantage of increasing the stability of maintenance through the collaboration between an expert at a remote location and a worker at a maintenance site.

Furthermore, the wearable display-based remote collaboration apparatus and method can visualize a maintenance work procedure and method provided by the expert at a remote location and then provide the visualized work procedure and method to the worker, thereby providing the advantages of performing accurate and rapid maintenance and rapidly taking countermeasures against an equipment failure even in an equipment operating environment in which the number of persons on board as well as accessibility are limited.

Moreover, the wearable display-based remote collaboration apparatus and method can visualize a maintenance work procedure and method provided by the expert at a remote location and then provide the visualized work procedure and method to the worker, thereby providing the advantages of minimizing maintenance personnel and reducing the cost of maintenance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wearable display-based remote collaboration apparatus, comprising:
an image acquisition unit configured to obtain image information associated with a present point of time of a worker;
a recognition unit configured to recognize a location and motion of the worker based on the obtained image information;
an image processing unit configured to match a virtual object, corresponding to an object of work included in the obtained image information, with the image information, and to match a motion of the object of work, matched with the image information, with the image information based on manipulation information; and
a visualization unit configured to visualize the image information processed by the image processing unit, and to output the visualized image information.

2. The wearable display-based remote collaboration apparatus of claim 1, wherein the recognition unit comprises a location recognition module configured to recognize the location of the worker based on the location information that is included in a signal from a Global Positioning System (GPS) or a signal from a wireless sensor network.

3. The wearable display-based remote collaboration apparatus of claim 2, wherein the location recognition module recognizes the location of the worker based on the obtained image information and information about an image of a work environment that has been previously obtained if the GPS or the wireless sensor network is unavailable.

4. The wearable display-based remote collaboration apparatus of claim 1, wherein the recognition unit comprises a motion recognition module configured to recognize the motion of the worker based on at least one of the obtained image information and information about a depth of a work space that is included in the obtained image information.

5. The wearable display-based remote collaboration apparatus of claim 1, wherein the image processing unit detects the virtual object, corresponding to the object of work included in the obtained image information, based on the location and motion of the worker recognized by the recognition unit, and matches the detected virtual object with the obtained image information.

6. The wearable display-based remote collaboration apparatus of claim 1, wherein the image processing unit tracks the virtual object, matched with the image information, based on the manipulation information, and sends results of the tracking to the visualization unit.

7. The wearable display-based remote collaboration apparatus of claim 1, further comprising a virtual object storage unit configured to store virtual objects that are generated based on blueprints of equipment.

8. The wearable display-based remote collaboration apparatus of claim 1, further comprising a communication unit configured to send the obtained image information to a collaboration support server and to receive manipulation information, corresponding to the transmitted image information, from the collaboration support server.

9. The wearable display-based remote collaboration apparatus of claim 8, wherein the communication unit sends the image information with which the virtual object has been matched by the image processing unit to the collaboration support server.

10. The wearable display-based remote collaboration apparatus of claim 1, further comprising a depth information acquisition unit configured to obtain information about a depth of a work space including at least one of equipment, a part, and a hand of the worker included in the image information that is obtained by the image acquisition unit.

11. A wearable display-based remote collaboration method, comprising:
obtaining, by an image acquisition unit, image information associated with a present point of time of a worker that is located at a work site;
recognizing, by a recognition unit, a location and motion of the worker based on the obtained image information;
matching, by an image processing unit, a virtual object, corresponding to an object of work included in the obtained image information, with the image information;
matching, by the image processing unit, a motion of the virtual object with the image information based on manipulation information that is received from a collaboration support server; and
visualizing, by a visualization unit, the matched image information, and outputting, by a visualization unit, the visualized image information.

12. The wearable display-based remote collaboration method of claim 11, wherein recognizing the location and motion of the worker comprises:
recognizing, by the recognition unit, the location of the worker based on location information that is included in a signal from a GPS or a signal from a wireless sensor network; or
recognizing, by the recognition unit, the location of the worker based on the obtained image information and information about an image of a work environment that has been previously obtained.

13. The wearable display-based remote collaboration method of claim 11, wherein recognizing the location and motion of the worker comprises recognizing, by the recognition unit, the motion of the worker based on at least one of the obtained image information and information about a depth of a work space that is included in the obtained image information.

14. The wearable display-based remote collaboration method of claim 11, wherein matching the virtual object with the image information comprises:
detecting, by the image processing unit, the virtual object, corresponding to the object of work included in the obtained image information, based on the location and motion of the worker recognized in the step of recognizing the location and motion of the worker; and
matching, by the image processing unit, the detected virtual object with the obtained image information.

15. The wearable display-based remote collaboration method of claim 11, wherein visualizing the matched image information and outputting the visualized image information comprises tracking, by the image processing unit, the virtual object, matched with the image information, based on the manipulation information, and sending, by the image processing unit, results of the tracking to the visualization unit.

16. The wearable display-based remote collaboration method of claim 11, further comprising obtaining, by a depth information acquisition unit, depth information of the obtained image information.

17. The wearable display-based remote collaboration method of claim 16, wherein obtaining the depth information comprises obtaining, by the depth information acquisition unit, information about a depth of a work space including at least one of equipment, a part, a hand of the worker that are included in the obtained image information.

18. The wearable display-based remote collaboration method of claim 11, further comprising sending, by the communication unit, the matched image information to the collaboration support server.

19. The wearable display-based remote collaboration method of claim 18, wherein sending the image information to the collaboration support server comprises sending, by the communication unit, the obtained image information to the collaboration support server.

20. The wearable display-based remote collaboration method of claim 18, further comprising receiving, by the communication unit, manipulation information corresponding to the transmitted image information from the collaboration support server.
